(19) United States
(12) Patent Application Publication
(10) Pub. No.: US 2019/0367044 A1
(43) Pub. Date: Dec. 5, 2019

(54) VEHICLE CONTROL SYSTEM

(71) Applicant: HONDA MOTOR CO., LTD., Tokyo (JP)

(72) Inventors: Akiko Nakagawara, Wako-shi (JP); Masayuki Sadakiyo, Wako-shi (JP); Takuro Shimizu, Wako-shi (JP)

(73) Assignee: HONDA MOTOR CO., LTD., Tokyo (JP)

(21) Appl. No.: 16/424,860

(22) Filed: May 29, 2019

(30) Foreign Application Priority Data
May 29, 2018 (JP) 2018-102504

(51) Int. Cl. B60W 50/08; G05D 1/00; B60W 30/18; B60W 40/068

(52) U.S. Cl. CPC B60W 50/08; G05D 1/0088; B60W 2050/007; B60W 40/068; B60W 30/18

(57) ABSTRACT

A vehicle control system includes: an automated driving controller performing automated driving control over a vehicle; a manual driving controller performing manual driving control; a driving mode shift controller shifting the driving mode between the automated driving control and the manual driving control; a μ estimation unit estimating a frictional coefficient μ of a road surface; a maximum frictional force calculation unit calculating the maximum frictional force between wheels and the road surface; a storage unit storing, during the automated driving control, the estimated μ and the calculated maximum frictional force; and a driving force distribution controller distributing, when the driving mode forcibly shifts from the automated driving control to the manual driving control and when driving force exceeding the stored maximum frictional force is input to one driving wheel, the driving force to another driving wheel.

### CROSS REFERENCES TO RELATED APPLICATIONS

The present application claims priority under 35 U.S.C. § 119 to Japanese Patent Application No. 2018-102504, filed May 29, 2018, entitled “VEHICLE CONTROL SYSTEM.” The contents of this application are incorporated herein by reference in their entirety.

### TECHNICAL FIELD

The present disclosure relates to a vehicle control system.

### BACKGROUND

Heretofore, a vehicle behavior control apparatus that improves the reliability of vehicle traveling has been proposed (see Japanese Patent No. 5307591, for example). The vehicle behavior control apparatus according to this Japanese Patent No. 5307591 is said to compensate delay in actuating an actuator and achieve responsiveness suitable for the travel state of a vehicle.

### SUMMARY

By the way, while examination of vehicle automated driving has been pushed forward recently, there is a possibility that, when the driving mode shifts from automated driving to manual driving without intention of a driver, the driver cannot apply appropriate driving force that has been applied in automated driving, which causes excessive slip of driving wheel.

Therefore, it is preferable to provide a vehicle control system that is capable of avoiding excessive slip of driving wheel when the driving mode shifts from automated driving to manual driving without intention of a driver.

One aspect of the present disclosure provides a vehicle control system (for example, a vehicle control system 1 to be described later) including: an automated driving controller (for example, an automated driving controller 11 to be described later) that performs automated driving control over a vehicle; a manual driving controller (for example, a manual driving controller 13 to be described later) that performs manual driving control over the vehicle in response to manipulation by a driver; and a driving mode shift controller (for example, a driving mode shift controller 12 to be described later) that shifts the driving mode between the automated driving control and the manual driving control, in which the vehicle control system includes: a μ estimation unit (for example, a μ estimation unit 14 to be described later) that estimates a frictional coefficient μ of a road surface on which the vehicle travels; a maximum frictional force calculation unit (for example, a maximum frictional force calculation unit 16 to be described later) that calculates the maximum frictional force between a wheel of the vehicle and the road surface based on the frictional coefficient μ estimated by the μ estimation unit; a storage unit (for example, a storage unit 15 to be described later) that stores, during the automated driving control, the frictional coefficient μ estimated by the μ estimation unit and the maximum frictional force calculated by the maximum frictional force calculation unit; and a driving force distribution controller (for example, an ECU 10 and an AWD 63 to be described later) that distributes, when the driving mode shift controller forcibly shifts the driving mode from the automated driving control to the manual driving control without intention of the driver and when driving force exceeding the maximum frictional force stored in the storage unit is input to one driving wheel of the vehicle, the driving force to a different driving wheel.

In the vehicle control system, it is preferable that the driving force distribution controller limits a total driving force if the driving force to be distributed to the different driving wheel exceeds the maximum frictional force stored in the storage unit.

In the vehicle control system, it is preferable that, if the frictional coefficient μ estimated by the μ estimation unit after the driving mode shift controller forcibly shifts the driving mode from the automated driving control to the manual driving control without intention of the driver changes, the storage unit updates the stored frictional coefficient μ with the changed frictional coefficient μ. In the above explanation of the exemplary embodiment, specific elements with their reference numerals are indicated by using brackets. These specific elements are presented as mere examples in order to facilitate understanding, and thus, should not be interpreted as any limitation to the accompanying claims.

According to the present disclosure, for example, it is possible to provide a vehicle control system that is capable of avoiding excessive slip of driving wheel when the driving mode shifts from automated driving to manual driving without intention of a driver.

### BRIEF DESCRIPTION OF THE DRAWINGS

FIG. 1 is a diagram illustrating the configuration of a vehicle control system according to an embodiment of the present disclosure.

FIG. 2 is a flowchart illustrating the procedure of driving force distribution control processing executed when the driving mode forcibly shifts from automated driving to manual driving without intention of a driver.

### DETAILED DESCRIPTION

Hereinbelow, an embodiment of the present disclosure is described in detail with reference to the drawings.

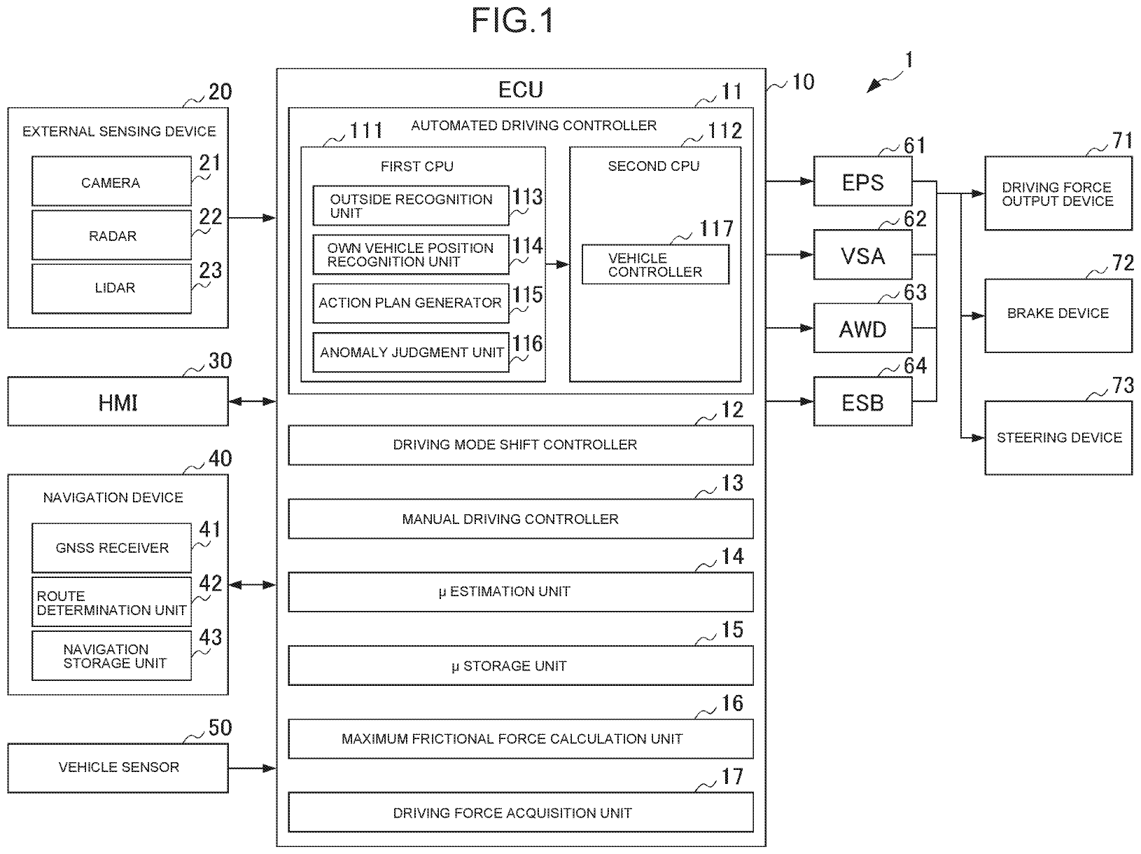

FIG. 1 is a diagram illustrating the configuration of a vehicle control system 1 according to the embodiment of the present disclosure. A vehicle mounted with the vehicle control system 1 according to this embodiment has the configuration of an electric vehicle capable of four-wheel drive, for example. As will be described in detail later, the vehicle control system 1 according to this embodiment has a configuration capable of automatic vehicle drive control, and capable of automated driving corresponding to Level 3 defined by Ministry of Land, Infrastructure and Transport.

As illustrated in FIG. 1, the vehicle control system 1 includes: an ECU 10; an external sensing device 20; an HMI (Human Machine Interface) 30; a navigation device 40; a vehicle sensor 50; an EPS (Electric Power Steering) 61; a VSA (Vehicle Stability Assist) 62; an AWD (All-Wheel-Drive) 63; an ESB (Electric Servo Brake) 64; a driving force output device 71; a brake device 72; and a steering device 73.

The external sensing device 20 includes: a camera 21; a radar 22; and a lidar 23.

At least one camera 21 is provided at a given position of own vehicle, and is configured to take images of the surrounding of the own vehicle to acquire image information. The camera 21 is a monocular camera or a stereo camera, and a digital camera using a solid-state image sensor such as a CCD or a CMOS is used as the camera, for example.

At least one radar 22 is provided at a given position of the own vehicle, and is configured to detect the position (distance and direction) of an object existing around the own vehicle. Specifically, the radar 22 detects the position of an object by: irradiating the surrounding of the vehicle with a millimetric electromagnetic wave, for example; and detecting a reflected wave obtained in such a manner that the output electromagnetic wave is reflected by the object.

At least one lidar 23 is provided at a given position of the own vehicle, and is configured to detect the position (distance and direction) and nature of an object existing around the own vehicle. Specifically, the lidar 23 detects the position and nature of an object existing at a position farther than the radar 22 by: irradiating the surrounding of the vehicle with an electromagnetic wave shorter in wavelength than a millimetric-wave (electromagnetic wave such as ultraviolet light, visible light, or near-infrared light) in a pulse fashion; and detecting a scattered wave obtained in such a manner that the output electromagnetic wave is scattered by the object.

The external sensing device 20 functions as an Advanced Driving Assistance System ADAS. Specifically, the external sensing device 20 is configured to comprehensively evaluate the information, acquired by devices such as the above camera 21, radar 22, and lidar 23, by use of the sensor fusion technology, and output more accurate information to the ECU 10 which will be described in detail later.

The HMI 30 is an interface configured to present a driver and the like with various information and accept input manipulation by the driver and the like. For example, the HMI 30 includes components such as a display device, a seatbelt device, a steering wheel touch sensor, a driver monitor camera, and various manipulation switches (all of which are not illustrated).

For example, the display device is a touch panel type display device configured to display images thereon and accept manipulation by a driver and the like. For example, the seatbelt device has a configuration including a seatbelt pretensioner and, when the driving mode shifts from automated driving to manual driving without intention of the driver due to reasons such as vehicle malfunction, it vibrates a seatbelt to inform and warn the driver. The steering wheel touch sensor is provided on a steering wheel of the vehicle, and configured to detect whether or not the driver touches the steering wheel and the pressure with which the driver grips the steering wheel. The driver monitor camera is configured to take images of a driver's face and upper body. The various manipulation switches have a configuration including components such as a GUI- or mechanical-type automated driving shift switch that gives instructions to start and stop automated driving, for example. In addition, the HMI 30 may include various communication devices having a function to communicate with the outside.

The navigation device 40 includes: a GNSS (Global Navigation Satellite System) receiver 41; a route determination unit 42; and a navigation storage unit 43. In addition, the navigation device 40 includes, in the HMI 30 described above, components such as a display device, a speaker, and a manipulation switch for a driver and the like to use the navigation device 40.

The GNSS receiver 41 is configured to identify the position of the vehicle based on a signal received from a GNSS satellite. Here, the GNSS receiver may identify the position of the vehicle by information acquired from the vehicle sensor 50 which will be described in detail later.

The route determination unit 42 is configured to determine, for example, the route from the position of the own vehicle identified by the GNSS receiver 41 to a destination input by a driver and the like, with reference to map information stored in the navigation storage unit 43 which will be described in detail later. The route determined by the route determination unit 42 is guided to the driver and the like via the components such as the display device and the speaker included in the HMI 30 described above.

The navigation storage unit 43 stores precise map information MPU (Map Position Unit). Examples of the map information include: the type of a road; the number of traffic lanes of the road; the location of an emergency parking zone; the width of each traffic lane; the slope of the road; the location of the road; the curvature of each lane curve; the positions of points where traffic lanes merge and where a traffic lane diverges; information on traffic signs etc.; information on the location of an intersection; information on whether or not a traffic light exists; information on the location of a halt line; traffic jam information; and other vehicles information.

Note that the navigation device 40 may be constituted of a terminal device such as a smartphone or a tablet terminal, for example. In addition, the navigation device 40 includes various cellular networks, an in-vehicle dedicated communication unit TCU (Telematics Communication Unit), and the like (all of which are not illustrated), and is capable of sending and receiving information with a cloud server and the like. Thereby, information such as vehicle position information is sent to the outside, and the above map information is updated as needed.

The vehicle sensor 50 includes multiple sensors for detecting various behaviors of the own vehicle. For example, the vehicle sensor 50 includes sensors such as: a vehicle speed sensor configured to detect the speed (vehicle speed) of the own vehicle; a wheel speed sensor configured to detect the speed of each wheel of the own vehicle; a longitudinal acceleration sensor configured to detect the acceleration and deceleration of the own vehicle; a lateral acceleration sensor configured to detect the lateral acceleration of the own vehicle; a yaw rate sensor configured to detect the yaw rate of the own vehicle; an orientation sensor configured to detect the orientation of the own vehicle; an inclination sensor configured to detect the inclination of the own vehicle.

In addition, the vehicle sensor 50 includes multiple sensors for detecting the amount of manipulation of each of various manipulation devices. For example, the vehicle sensor 50 includes sensors such as: an accelerator pedal sensor configured to detect the amount of depression (opening angle) of an accelerator pedal; a rudder angle sensor configured to detect the amount of manipulation (steering angle) of a steering wheel; a torque sensor configured to detect a steering torque; a brake pedal sensor configured to detect the amount of depression of a brake pedal; and a shift sensor configured to detect the position of a shift lever.

The EPS 61 is a so-called electric power steering device. The EPS 61 is equipped with EPS-ECU (not illustrated), and is configured to change the orientation of a wheel (steering wheel) by controlling the steering device 73 to be described later in accordance with a control command that is output from the ECU 10 which will be described in detail later.

The VSA 62 is a so-called vehicle behavior stabilization control device. The VSA 62 is equipped with VSA-ECU (not illustrated), and has: an ABS function to prevent wheels from being locked up during braking manipulation; a TCS (Traction Control System) function to prevent slip of wheels during acceleration, for example; a function to prevent lateral skidding and the like during turning; and a function to perform emergency braking control irrespective of the driver's braking manipulation in the event of collision of the own vehicle. In order to implement these functions, the VSA 62 adjusts brake fluid pressure generated in the ESB 64 to be described later and thereby supports vehicle behavior stabilization.

Specifically, the VSA 62 is configured to control the brake device 72 to be described later based on the vehicle speed, the steering angle, the yaw rate, the lateral acceleration, and the like detected by the vehicle speed sensor, the rudder angle sensor, the yaw rate sensor, and the lateral acceleration sensor described above. To be more specific, the VSA controls a fluid pressure unit configured to supply brake fluid pressure to a brake cylinder of each of front and rear, left and right wheels, and thereby controls the braking force of each wheel individually and improves travel stability.

The AWD 63 is a so-called flexible all-wheel drive control system, and functions as a driving force distribution controller. In other words, the AWD 63 is equipped with AWD-ECU (not illustrated), and configured to flexibly control front and rear, left and right wheels' driving force distribution. More specifically, the AWD 63 controls an electromagnetic clutch, a driving motor, and the like in a front-and-rear left-and-right driving force distribution unit based on the vehicle speed, the steering angle, the yaw rate, the lateral acceleration, and the like detected by the vehicle speed sensor, the rudder angle sensor, the yaw rate sensor, and the lateral acceleration sensor, and thereby changes front and rear, left and right wheels' driving force distribution.

In addition, as will be described in detail later, when a driving mode shift controller 12 forcibly shifts the driving mode from automated driving control to manual driving control without intention of a driver and when driving force exceeding the maximum frictional force stored in a storage unit 15 is input to one driving wheel of the vehicle, for example, the AWD 63 that functions as the driving force distribution controller distributes the driving force to another driving wheel. This will be described in detail later.

The ESB 64 is equipped with ESB-ECU (not illustrated), and configured to generate braking force on wheels by controlling the brake device 72 to be described later in accordance with a control command output from the ECU 10 which will be described in detail later.

The driving force output device 71 is constituted of an electric motor or the like which is a driving source of the own vehicle. The driving force output device 71 is configured to generate traveling driving force (torque) for the own vehicle to travel in accordance with a control command output from the ECU 10 which will be described in detail later, and transmit the torque to each wheel via a transmission.

The brake device 72 is constituted of an electric servo brake which also functions as a hydraulic brake, for example. The brake device 72 is configured to brake wheels in accordance with a control command output from the ECU 10 which will be described in detail later.

The steering device 73 is configured to change the orientation of a wheel (steering wheel) under control of the EPS 61 described above.

Next, the ECU 10 included in the vehicle control system 1 according to this embodiment is described in detail.

As illustrated in FIG. 1, the ECU 10 includes: an automated driving controller 11; the driving mode shift controller 12; a manual driving controller 13; a μ estimation unit 14; the storage unit 15; a maximum frictional force calculation unit 16; and a driving force acquisition unit 17.

The automated driving controller 11 has a configuration including a first CPU 111 and a second CPU 112.

The first CPU 111 has a configuration including: an outside recognition unit 113; an own-vehicle position recognition unit 114; an action plan generator 115; and an anomaly judgment unit 116.

The outside recognition unit 113 is configured to recognize an outside object (object to be recognized) and recognize its position based on various information acquired by the external sensing device 20 described above. Specifically, the outside recognition unit 113 recognizes obstacles, road shapes, signal lights, guardrails, power poles, surrounding vehicles (including their travel state, such as speed and acceleration, and parking state), lane marks, pedestrians, and the like and their positions.

The own-vehicle position recognition unit 114 is configured to recognize the current position and posture of the own vehicle based on positional information on the own vehicle measured by the navigation device 40 described above and various sensor information detected by the vehicle sensor 50 described above. Specifically, the own-vehicle position recognition unit 114 compares the map information with an image, acquired by the camera 21, to recognize a traffic lane that the own vehicle is traveling and recognize the relative position and posture of the own vehicle relative to this traffic lane.

The action plan generator 115 is configured to generate an automated driving action plan for the own vehicle to reach a destination or the like. Specifically, the action plan generator 115 generates an automated driving action plan, based on outside information recognized by the outside recognition unit 113 described above and own-vehicle positional information recognized by the own-vehicle position recognition unit 114 described above, so that the vehicle can travel on a route determined by the route determination unit 42 described above while responding to the state of the own vehicle and the surrounding circumstances.

Specifically, the action plan generator 115 generates a target trajectory that the own vehicle will follow in the future. To be more specific, the action plan generator 115 generates multiple target trajectory candidates, and selects the optimum target trajectory at that point in terms of safety and efficiency. In addition, when the anomaly judgment unit 116 which will be described in detail later judges that an occupant or the own vehicle is in an abnormal condition, the action plan generator 115 generates an action plan for letting the own vehicle park at a safe location (such as an emergency parking zone, side strip, shoulder, and parking area), for example.

The anomaly judgment unit 116 is configured to judge whether or not at least one of a driver and the own vehicle is in an abnormal condition. For example, the driver's abnormal condition includes physical condition deterioration including a state where an occupant is sleeping and a state where an occupant is unconscious due to sickness etc. Meanwhile, the own vehicle's abnormal condition includes own vehicle malfunction, for example.

Specifically, the anomaly judgment unit 116 judges the driver's abnormal condition by analyzing an image acquired by the driver monitor camera described above. In addition, the anomaly judgment unit 116 judges that the driver is in an abnormal condition if cautionary notices are given to the driver a predetermined number of times or more by way of means such as display, audio, or seatbelt vibration when the driving mode forcibly shifts from automated driving to manual driving without intention of the driver due to reasons such as own vehicle malfunction and if no manual driving operation of the driver is detected despite the notices. The manual driving operation of the driver is detected by sensors such as the steering wheel touch sensor, the accelerator pedal sensor, and the brake pedal sensor described above.

In addition, the anomaly judgment unit 116 detects whether or not malfunction of the own vehicle exists based on the various sensor information acquired by the vehicle sensor 50 and the like described above, and judges that the own vehicle is in an abnormal condition if the malfunction is detected.

The second CPU 112 has a configuration including a vehicle controller 117. To the vehicle controller 117 constituting the second CPU 112, the outside information, own-vehicle positional information, action plan, and anomaly information acquired by the first CPU 111 described above are input.

The vehicle controller 117 is configured to start/stop automated driving according to an automated driving start/stop signal input from the automated driving shift switch described above. In addition, the vehicle controller 117 is configured to control the driving force output device 71, the brake device 72, and the steering device 73 via devices such as the EPS 61, the VSA 62, the AWD 63, and the ESB 64 described above so that the own vehicle can travel at a target speed along the target trajectory generated by the action plan generator 115.

The driving mode shift controller 12 is configured to shift the driving mode between automated driving and manual driving according to a signal input from the automated driving shift switch described above. For example, the driving mode shift controller 12 shifts the driving mode based on an acceleration, deceleration, or steering instruction operation made to the accelerator pedal, the brake pedal, the steering wheel, or the like. In addition, the driving mode shift controller 12 shifts the driving mode from automated driving to manual driving at a location near a planned automated driving end point set by the action plan generated by the action plan generator 115, for example. Further, if the anomaly judgment unit 116 described above judges that the own vehicle is in an abnormal condition due to reasons such as malfunction of the own vehicle, the driving mode shift controller 12 shifts to manual driving control without executing automated driving control.

The manual driving controller 13 is configured to execute control that is necessary for the own vehicle to travel by the driver's manual driving. The manual driving controller 13 controls devices such as the driving force output device 71, the brake device 72, and the steering device 73 described above based on the driver's operation on the steering wheel, the accelerator pedal, the brake pedal, and the like.

The μ estimation unit 14 is configured to estimate a frictional coefficient μ of a road surface on which the own vehicle travels. The μ estimation unit 14 estimates the frictional coefficient μ at predetermined cycles while the own vehicle is traveling, irrespective of whether the own vehicle is in automated driving control or in manual driving control. A specific example of frictional coefficient μ estimation method is to estimate the frictional coefficient μ based on the vehicle speed acquired by the vehicle speed sensor and the wheel speed of each wheel acquired by the wheel speed sensor. Alternatively, the frictional coefficient μ is estimated based on the vehicle speed acquired by the vehicle speed sensor, the rudder angle acquired by the rudder angle sensor, and the yaw rate acquired by the yaw rate sensor. Note that the μ estimation method is not limited to these.

The maximum frictional force calculation unit 16 is configured to calculate the maximum frictional force between the wheels of the own vehicle and the road surface based on the frictional coefficient μ estimated by the μ estimation unit 14 described above. Specifically, the maximum frictional force calculation unit determines a friction circle based on the frictional coefficient μ estimated by the p estimation unit 14 by referring to the relationship between the frictional coefficient μ and the size of friction circle which is stored in advance. Thereby, the maximum frictional force that prevents excessive slip of wheels is calculated.

Here, it is also possible to deem that vehicles travel while causing minute slip of driving wheels constantly even on a dry road surface with large μ. Thus, the “excessive slip” in this embodiment excludes such minute slip.

The storage unit 15 is configured to store, during automated driving control, the frictional coefficient μ estimated by the P estimation unit 14 described above and the maximum frictional force calculated by the maximum frictional force calculation unit 16 described above based on the frictional coefficient μ thus estimated. More specifically, the storage unit 15 stores the frictional coefficient μ, which is estimated immediately before the driving mode forcibly shifts from automated driving to manual driving without intention of a driver, and the maximum frictional force, for example.

The driving force acquisition unit 17 is configured to calculate and acquire driving force required for the vehicle. Specifically, using a previously-stored map and the like, the driving force acquisition unit 17 acquires driving force required to be output from an output shaft based on: the vehicle speed acquired by the vehicle speed sensor described above; the amount of manipulation of the accelerator pedal acquired by the accelerator pedal sensor; the amount of manipulation of the brake pedal acquired by the brake pedal sensor; and the like.

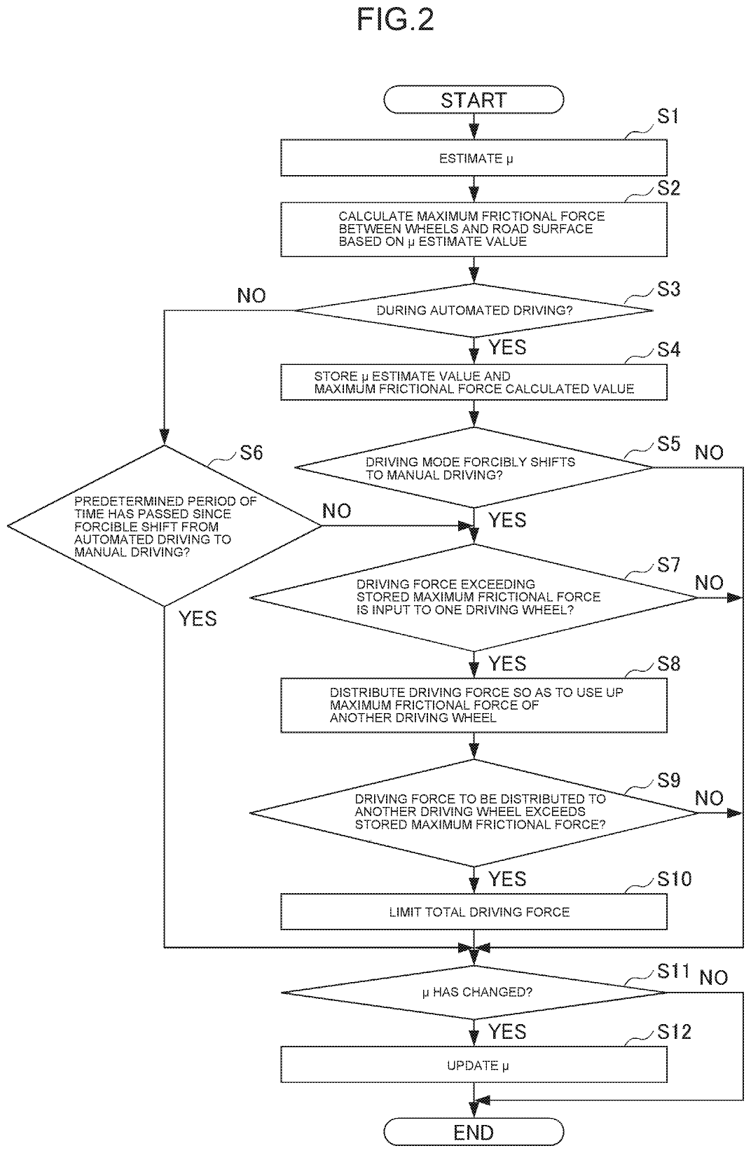

Next, with reference to FIG. 2, a detailed description is given of driving force distribution control that is executed by the vehicle control system 1 of this embodiment having the above configuration when the driving mode forcibly shifts from automated driving to manual driving without intention of a driver, for example.

Here, FIG. 2 is a flowchart illustrating the procedure of driving force distribution control processing executed when the driving mode forcibly shifts from automated driving to manual driving without intention of a driver. The driving force distribution control processing illustrated in FIG. 2 is iterated at predetermined cycles during automated driving control.

In Step S1, the vehicle control system estimates the frictional coefficient μ of a road surface on which the own vehicle travels. After the estimation is over, the process proceeds to Step S2.

In Step S2, the system calculates the maximum frictional force (friction circle) between the wheels of the own vehicle and the road surface based on the frictional coefficient μ estimate value estimated in Step S1. After the calculation is over, the process proceeds to Step S3.

In Step S3, the system judges whether or not the own vehicle is in automated driving control. If YES, the process proceeds to Step S4; if NO, the process proceeds to Step S6.

In Step S4, the system stores the frictional coefficient μ estimate value estimated in Step S1 and the maximum frictional force calculated value calculated in Step S3. After they are stored, the process proceeds to Step S5.

In Step S5, the system judges whether or not the driving mode forcibly shifts from automated driving control to manual driving control. For example, the system judges whether or not the driving mode forcibly shifts from automated driving control to manual driving control without intention of a driver due to reasons such as malfunction of the own vehicle. If YES, the process proceeds to Step S7; if NO, the process proceeds to Step S11.

In Step S6, the system judges whether or not a predetermined period of time has passed since the driving mode forcibly shifted from automated driving control to manual driving control. If YES, the process proceeds to Step S11; if NO, the process proceeds to Step S7. Examples of the case where this judgment result is YES include the case where the driving mode has been kept at manual driving and the case where the driving mode has shifted to manual driving control via the shift switch.

In Step S7, the system judges whether or not driving force exceeding the maximum frictional force stored in Step S4 is input to one driving wheel. If YES, the process proceeds to Step S8; if NO, the process proceeds to Step S11.

Here, one driving wheel may be a front wheel or a rear wheel, for example, or alternatively may be any one of front, rear, left, and right wheels.

In Step S8, the system distributes the driving force so as to use up the maximum frictional force of another driving wheel. Then, the process proceeds to Step S9.

Here, when one driving wheel is a front wheel or a rear wheel, another driving wheel is a rear wheel or a front wheel; when one driving wheel is any one of front, rear, left, and right wheels, another driving wheel is at least one of the remaining three wheels.

In Step S9, the system judges whether or not the driving force to be distributed to another driving wheel in Step S8 exceeds the maximum frictional force stored in Step S4. If YES, the process proceeds to Step S10; if NO, the process proceeds to Step S11.

In Step S10, the system limits the total driving force to be input to the driving wheel. Specifically, the system controls the driving force output device such as an electric motor and thereby limits the total driving force so that the driving force to be distributed to another driving wheel may not exceed the maximum frictional force. Then, the process proceeds to Step S11.

In Step S11, the system judges whether or not the frictional coefficient μ, estimated after the driving mode shifted from automated driving control to manual driving control, has changed from the frictional coefficient μ stored in Step S4. If YES, the process proceeds to Step S12; if NO, the processing terminates.

In Step S12, the system updates the frictional coefficient μ during automated driving control, stored in Step S4, with the frictional coefficient μ having changed after the driving mode shifted from automated driving control to manual driving control, and terminates the processing.

The vehicle control system according to this embodiment having been described above brings about the following effect.

The vehicle control system according to this embodiment is provided with: the μ estimation unit that estimates the frictional coefficient μ of the road surface; the maximum frictional force calculation unit that calculates the maximum frictional force between the wheels and the road surface based on the frictional coefficient μ thus estimated; and the storage unit that stores the frictional coefficient μ thus estimated and the maximum frictional force thus calculated during automated driving control. The system is further provided with the driving force distribution controller that distributes driving force to another driving wheel when the driving mode forcibly shifts from automated driving control to manual driving control without intention of a driver and when driving force exceeding the maximum frictional force stored in the storage unit is input to one driving wheel.

This makes it possible to suppress excessive slip of driving wheel when the driving mode shifts from automated driving to manual driving without intention of the driver. As an example, the driver is highly likely to depress the accelerator pedal deeply if the driving mode forcibly shifts from automated driving control to manual driving control without intention of the driver due to reasons such as malfunction of the own vehicle when the vehicle is under automated driving control while traveling on a climbing lane with small μ, for example. In this case, there is a risk of excessive slip of a front wheel; on the other hand, according to this embodiment, the system distributes driving force to a rear wheel if driving force exceeding the maximum frictional force is input to the front wheel, whereby excessive slip of the front wheel can be avoided.

In addition, in this embodiment, the system limits the total driving force if the driving force to be distributed to another driving wheel exceeds the maximum frictional force stored in the storage unit. Thereby, it is possible to reliably avoid excessive slip of driving wheel. In the example described above, the system limits the total driving force when the driving force to be distributed to the rear wheel exceeds the maximum frictional force, and thus it is also possible to avoid excessive slip of the rear wheel.

Further, in this embodiment, if the frictional coefficient μ estimated after the driving mode forcibly shifted from automated driving control to manual driving control without intention of the driver changes, the system updates the stored frictional coefficient μ with the changed frictional coefficient μ. Thereby, appropriate driving force distribution is possible in later manual driving control.

Note that the present invention is not limited to the above embodiment, and includes modifications, improvements, etc. as long as the objective of the present invention can be achieved.

For example, in the above embodiment, an electric automated vehicle has been taken as an example of the vehicle equipped with the vehicle control system 1; instead, vehicles such as an engine vehicle, a hybrid vehicle, and a fuel cell vehicle may be equipped with the vehicle control system 1. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

1. A vehicle control system comprising:
an automated driving controller that performs automated driving control over a vehicle;
a manual driving controller that performs manual driving control over said vehicle in response to operation by a driver;
a driving mode shift controller that shifts a driving mode between said automated driving control and said manual driving control;
a μ estimation unit that estimates a frictional coefficient μ of a road surface on which said vehicle travels;
a maximum frictional force calculation unit that calculates the maximum frictional force between a wheel of said vehicle and said road surface based on said frictional coefficient μ estimated by said μ estimation unit;
a storage device that stores, during said automated driving control, said frictional coefficient μ estimated by said μ estimation unit and the maximum frictional force calculated by said maximum frictional force calculation unit; and
a driving force distribution controller that distributes a driving force among driving wheels of said vehicle, said driving force distribution controller distributing, when said driving mode shift controller forcibly shifts said driving mode from said automated driving control to said manual driving control without intention of said driver and when inputting driving force exceeding the maximum frictional force stored in said storage device is input to one of said driving wheels of said vehicle, said inputting driving force to a different driving wheel.

2. The vehicle control system according to claim 1, wherein said driving force distribution controller limits a total driving force when said driving force to be distributed to said different driving wheel exceeds the maximum frictional force stored in said storage device.

3. The vehicle control system according to claim 1, wherein, when said frictional coefficient μ estimated by said μ estimation unit changes after said driving mode shift controller forcibly shifts said driving mode from said automated driving control to said manual driving control without intention of said driver, said storage device updates said stored frictional coefficient μ with said changed frictional coefficient μ.

4. The vehicle control system according to claim 2, wherein said total driving force is a total of driving force generated by a power unit of said vehicle to satisfy a required driving force according to acceleration instruction.

5. A vehicle control method executed by a computer equipped with a vehicle, wherein the vehicle comprises:
an automated driving controller that performs automated driving control over a vehicle,
a manual driving controller that performs manual driving control over said vehicle in response to operation by a driver, and
a driving mode shift controller that shifts a driving mode between said automated driving control and said manual driving control,
wherein the method comprises the steps of:
estimating a frictional coefficient μ of a road surface on which said vehicle travels;
calculating the maximum frictional force between a wheel of said vehicle and said road surface based on said estimated frictional coefficient μ;
storing, during said automated driving control, said estimated frictional coefficient μ and the calculated maximum frictional force into a storage device; and
when said driving mode shift controller forcibly shifts said driving mode from said automated driving control to said manual driving control without intention of said driver and when inputting driving force exceeding the stored maximum frictional force is input to one of driving wheels of said vehicle, distributing said inputting driving force to a different driving wheel.
